(19) United States
(12) Patent Application Publication
(10) Pub. No.: US 2014/0267193 A1
(43) Pub. Date: Sep. 18, 2014

(54) INTERACTIVE INPUT SYSTEM AND METHOD

(71) Applicant: Rob Barton, Calgary (CA)

(72) Inventor: Rob Barton, Calgary (CA)

(73) Assignee: SMART Technologies ULC, Calgary (CA)

(21) Appl. No.: 14/206,351

(22) Filed: Mar. 12, 2014

Related U.S. Application Data
(60) Provisional application No. 61/783,383, filed on Mar. 14, 2013.

(51) Int. Cl. G06F 3/038

(52) U.S. Cl. CPC G06F 3/0386
USPC 345/182

(57) ABSTRACT

A method of determining pointer position in an interactive input system comprises identifying pixels of at least one captured image frame as being associated with coherent light; generating a processed image frame from the identified pixels; and determining from the processed image frame a position of at least one pointer that emits coherent light.

### CROSS-REFERENCE TO RELATED APPLICATION

This application claims the benefit of U.S. Provisional Application No. 61/783,383 to Barton filed on Mar. 14, 2013, entitled “Interactive Input System and Method”, the entire content of which is incorporated herein by reference.

### FIELD

The subject disclosure relates to an interactive input system and method.

### BACKGROUND

Interactive input systems that allow users to inject input (i.e. digital ink, mouse events etc.) into an application program using an active pointer (e.g. a pointer that emits light, sound or other signal), a passive pointer (e.g. a finger, cylinder or other suitable object) or other suitable input device such as for example, a mouse or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the entire disclosures of which are incorporated herein by reference; touch systems comprising touch panels employing electromagnetic, capacitive, acoustic or other technologies to register pointer input; laptop and tablet personal computers (PCs); smartphones, personal digital assistants (PDAs) and other handheld devices; and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports imaging devices in the form of digital cameras at its corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

U.S. Pat. No. 6,281,878 to Montellese discloses an input device for detecting input with respect to a reference plane. The input device includes a light sensor positioned to sense light at an acute angle with respect to the reference plane and for generating a signal indicative of sensed light, and a circuit responsive to the light sensor for determining a position of an object with respect to the reference plane.

U.S. Patent Application Publication No. 2011/0242060 to McGibney et al., assigned to SMART Technologies ULC, discloses an interactive input system comprising at least one imaging assembly having a field of view looking into a region of interest and capturing image frames, and processing structure in communication with the at least one imaging assembly. When a pointer exists in captured image frames, the processing structure demodulates the captured image frames to determine frequency components thereof and examines the frequency components to determine at least one attribute of the pointer.

U.S. Pat. No. 6,219,011 to Aloni et al. discloses an electro-optical display apparatus that includes a plurality of modular units each having a projector for receiving electrical signals, converting them to optical images, and projecting the optical images via an optical projection system onto a screen. The modular units are arranged in a side-by-side array so as to produce a combined display on the screen. A calibration system detects distortions in the combined display caused by the projection system of each modular unit and modifies the electrical signals applied to the projector of each modular unit to correct the combined display with respect to the detected distortions.

One disadvantage of machine vision interactive input systems is that they are susceptible to ambient light, which can cause light artifacts to appear in captured image frames. Such artifacts can cause inaccuracies when processing the captured image frames in order to determine pointer locations. Several approaches have been considered to deal with ambient light, and include calculating difference image frames to cancel out ambient light, using modulated light sources and using light-emitting pen tools in conjunction with an optical filter overlaying the image sensor of the imaging devices, whereby light emitted by the pen tools is frequency matched to the optical filter so that it may pass through the optical filter to the image sensor. These approaches often improve the ability of the interactive input system to deal with ambient light, but can add to the cost of the interactive input system due to the requirement for additional bezels, filters, light sources and/or computer processing power.

As a result, improvements are desired. It is therefore an object to provide a novel interactive input system and method.

### SUMMARY

Accordingly, in one aspect there is provided a method of determining pointer position in an interactive input system, the method comprising: identifying pixels of at least one captured image frame as being associated with coherent light; generating a processed image frame from the identified pixels; and determining from the processed image frame a position of at least one pointer that emits coherent light.

In one embodiment, the identifying comprises determining an intensity variance for pixels of the at least one captured image frame and identifying pixels having an intensity variance above a threshold value as the identified pixels. The method may further comprise determining a mean intensity for the pixels of the at least one captured image frame. In one embodiment, the mean intensity is used as the threshold value while in another embodiment, the mean intensity plus one or more standard deviations of estimated noise is used as the threshold value.

In one embodiment, the at least one pointer emits coherent light and is in the form of a pen tool having a diffused tip section configured to emit the coherent light. The coherent light may be coherent infrared light.

According to another aspect, there is provided an interactive input system comprising: at least one imaging device configured to capture image frames of a region of interest; and one or more processors configured to process captured image frames to identify pixels associated with coherent light; generate processed image frames from the identified pixels and determine from the processed image frames a position of at least one pointer that emits coherent light.

According to yet another aspect, there is provided a method of processing image frames captured in an interactive system, the method comprising: determining an intensity variance for pixels of the captured image frame; identifying pixels having an intensity variance above a threshold value as being associated with coherent light; and generating a processed image frame from the identified pixels.

According to yet another aspect, there is provided an interactive input system comprising: at least one imaging device capturing image frames of a region of interest; and one or more processors configured to process captured image frames to: determine an intensity variance for pixels of captured image frames, identify pixels having an intensity variance above a threshold value as being associated with coherent light, and generate processed image frames from the identified pixels.

According to yet another aspect, there is provided a non-transitory computer readable medium embodying program code, which when executed by one or more processors, causes an apparatus at least to determine an intensity variance for pixels of captured image frames; identify pixels having an intensity variance above a threshold value as being associated with coherent light; and generate processed image frames from the identified pixels.

### BRIEF DESCRIPTION OF THE DRAWINGS

Embodiments will now be described more fully with reference to the accompanying drawings in which:

FIG. 1 is a perspective view of an interactive input system;

FIG. 2 is a schematic front elevational view of the interactive input system of FIG. 1;

FIG. 3 is a block diagram of an imaging assembly forming part of the interactive input system of FIG. 1;

FIG. 4 is a side elevational view of a pen tool used with the interactive input system of FIG. 1;

FIG. 5 is a block diagram of a master controller forming part of the interactive input system of FIG. 1;

FIG. 6 is an image frame captured by an imaging device of interactive input system of FIG. 1;

FIG. 7 is a flowchart showing steps of an image frame processing method used by the interactive input system of FIG. 1;

FIG. 8 is a processed image frame generated from a set of image frames, including the image frame of FIG. 6, using the image frame processing method of FIG. 7;

FIG. 9 is a perspective view of an alternative interactive input system;

FIG. 10 is a schematic front view of the interactive input system of FIG. 9;

FIG. 11 is a schematic side view of the interactive input system of FIG. 9;

FIG. 12 is an image frame captured by an imaging device forming part of the interactive input system of FIG. 9;

FIG. 13 is a flowchart showing steps of an image frame processing method used by the interactive input system of FIG. 9; and

FIG. 14 is a processed image frame generated from the image frame of FIG. 12 using the image frame processing method of FIG. 13.

### DETAILED DESCRIPTION OF THE EMBODIMENTS

Turning now to FIGS. 1 and 2, an interactive input system that allows a user to inject input such as digital ink, mouse events, commands etc. into an executing application program is shown and is generally identified by reference numeral 20. In this embodiment, interactive input system 20 comprises an assembly 22 that engages a display unit (not shown) such as for example, a plasma television, a liquid crystal display (LCD) device, a flat panel display device, a cathode ray tube etc. and surrounds the display surface 24 of the display unit. The assembly 22 employs machine vision to detect pointers brought into a region of interest in proximity with the display surface 24 and communicates with at least one digital signal processor (DSP) unit 26 via communication lines 28. The communication lines 28 may be embodied in a serial bus, a parallel bus, a universal serial bus (USB), an Ethernet connection or other suitable wired connection. The DSP unit 26 in turn communicates with a general purpose computing device 30 executing one or more application programs via a universal serial bus (USB) cable 32. Alternatively, the DSP unit 26 may communicate with the computing device 30 over another wired connection such as for example, a parallel bus, an RS-232 connection, an Ethernet connection etc. or may communicate with the computing device 30 over a wireless connection using a suitable wireless protocol such as for example Bluetooth, WiFi, ZigBee, ANT, IEEE 802.15.4, Z-Wave etc. Computing device 30 processes the output of the assembly 22 received via the DSP unit 26 and adjusts image data that is output to the display unit, if required, so that the image presented on the display surface 24 reflects pointer activity. In this manner, the assembly 22, DSP unit 26 and computing device 30 allow pointer activity proximate to the display surface 24 to be recorded as writing or drawing or used to control execution of one or more application programs executed by the computing device 30.

Assembly 22 comprises a frame assembly that is integral with or attached to the display unit and surrounds the display surface 24. Frame assembly comprises a bezel having three bezel segments 40 to 44, four corner pieces 46 and a tool tray segment 48. Bezel segments 40 and 42 extend along opposite side edges of the display surface 24 while bezel segment 44 extends along the top edge of the display surface 24. The tool tray segment 48 extends along the bottom edge of the display surface 24 and supports one or more pen tools P and an eraser tool (not shown). The corner pieces 46 adjacent the top left and top right corners of the display surface 24 couple the bezel segments 40 and 42 to the bezel segment 44. The corner pieces 46 adjacent the bottom left and bottom right corners of the display surface 24 couple the bezel segments 40 and 42 to the tool tray segment 48. In this embodiment, the corner pieces 46 adjacent the bottom left and bottom right corners of the display surface 24 accommodate imaging assemblies 60 that look generally across the entire display surface 24 from different vantages. The bezel segments 40 to 44 are oriented so that their inwardly facing surfaces are seen by the imaging assemblies 60. In this embodiment, the inwardly facing surfaces of each of the bezel segments 40 to 44 has a light absorbing material thereon.

Turning now to FIG. 3, one of the imaging assemblies 60 is better illustrated. As can be seen, the imaging assembly 60 comprises an image sensor 70 such as that manufactured by Micron under model No. MT9V022 fitted with an 880 nm lens of the type manufactured by Boowon under model No. BW25B. The lens has an IR-pass/visible light blocking filter thereon (not shown) and provides the image sensor 70 with a 98 degree field of view so that the entire display surface 24 is seen by the image sensor 70. The image sensor 70 is connected to a connector 72 that receives one of the communication lines 28 via an I²C serial bus. The image sensor 70 is also connected to an electrically erasable programmable read only memory (EEPROM) 74 that stores image sensor calibration parameters as well as to a clock (CLK) receiver 76, a serializer 78 and a current control module 80. The clock receiver 76 and the serializer 78 are also connected to the connector 72. Current control module 80 is connected to a power supply 84 and the connector 72.

The clock receiver 76 and serializer 78 employ low voltage, differential signaling (LVDS) to enable high speed communications with the DSP unit 26 over inexpensive cabling. The clock receiver 76 receives timing information from the DSP unit 26 and provides clock signals to the image sensor 70 that determine the rate at which the image sensor 70 captures and outputs image frames. Each image frame output by the image sensor 70 is serialized by the serializer 78 and output to the DSP unit 26 via the connector 72 and communication lines 28.

FIG. 4 shows an active pen tool P for use with the interactive input system 20. The pen tool P has a main body 182 terminating in a generally conical tip 184. The tip 184 is constructed from a generally transparent material and has a rough exterior surface. The tip 184 houses an illumination source configured to emit coherent light. In this embodiment, the illumination source comprises one or more miniature infrared (IR) laser diodes. The rough exterior surface of transparent tip 184 diffuses coherent light emitted by the illumination source as it passes therethrough. The diffused coherent light exiting the transparent tip 184 is frequency matched to the IR-pass/visible light blocking filters of the imaging assemblies 60. As a result, the diffused coherent light emitted by the pen tool P is able to pass through the blocking filters to the image sensors 70. The illumination source is powered by a battery (not shown) housed in the main body 182. Protruding from the tip 184 is an actuator 186 that resembles a nib. Actuator 186 is biased out of the tip 184 by a spring (not shown) but can be pushed into the tip 184 upon application of pressure thereto. The actuator 186 is connected to a switch (not shown) within the main body 182 that closes a circuit to power the illumination source when the actuator 186 is pushed against the spring bias and into the tip 184. An exemplary pointer tip switch is described in U.S. Patent Application Publication No. 2009/0277694 to Hansen et al. filed on May 9, 2008 and assigned to SMART Technologies ULC, the relevant portions of the disclosure of which are incorporated herein by reference.

Turning now to FIG. 5, the DSP unit 26 is better illustrated. As can be seen, DSP unit 26 comprises a controller 120 such as for example, a microprocessor, microcontroller, DSP etc. having a video port VP connected to connectors 122 and 124 via deserializers 126. The controller 120 is also connected to each connector 122, 124 via an I²C serial bus switch 128. I²C serial bus switch 128 is connected to clocks 130 and 132, each clock of which is connected to a respective one of the connectors 122, 124. The controller 120 communicates with an external antenna 136 via a wireless receiver 138, a USB connector 140 that receives USB cable 32 and memory 142 including volatile and non-volatile memory. The clocks 130 and 132 and deserializers 126 similarly employ low voltage, differential signaling (LVDS).

The computing device 30 in this embodiment is a personal computer or other suitable processing device comprising, for example, a processing unit comprising one or more processors, system memory (volatile and/or non-volatile memory), other non-removable or removable memory (eg. a hard disk drive, RAM, ROM, EEPROM, CD-ROM, DVD, flash memory, etc.) and a system bus coupling the various computer components to the processing unit. The computing device 30 may also comprise a network connection to access shared or remote drives, one or more networked computers, or other networked devices.

During operation, the controller 120 conditions the clocks 130 and 132 to output clock signals that are conveyed to the imaging assemblies 60 via the communication lines 28. The clock receiver 76 of each imaging assembly 60 uses the clock signals to set the frame rate of its associated image sensor 70. In this embodiment, the controller 120 generates clock signals such that the image frame capture rate is 480 frames per second, and which results in the frame rate of each image sensor 70 being four (4) times a desired image frame output rate.

Each imaging assembly 60 typically sees a generally dark region as a result of the light absorbing material on the inwardly facing surfaces of the bezel segments 40 to 44, as well as artifacts resulting from ambient light. If an active pen tool P is brought into contact with the display surface 24 with sufficient force to push the actuator 186 into the tip 184, each imaging assembly 60 will also see an illuminated region corresponding to the illuminated tip 184 of the pen tool P. For example, FIG. 6 shows an image frame captured by an imaging assembly 60, and which is generally indicated by reference numeral 350. In this example, image frame 350 comprises a dark region 302 corresponding to one or more of the bezel segments 40 to 44, bright regions 304 corresponding to artifacts resulting from ambient light, and a bright region 354 corresponding to the illuminated tip 184 of the pen tool P.

As mentioned above, each imaging assembly 60 captures successive images frames and conveys the captured image frames to the DSP unit 26. As each image frame is received, the controller 120 stores the image frame in a buffer. For each imaging assembly 60, once four (4) successive image frames 302 are available, the DSP unit 26 subjects the set of four (4) successive image frames to an image frame processing method, which is shown in FIG. 7 and generally indicated by reference numeral 400. Initially, the DSP unit 26 calculates a mean intensity and a variance of intensity for each pixel location of the set of four (4) image frames (step 404). Each pixel location comprises a set of pixel coordinates corresponding to the location of a pixel within an image frame, and is common to all image frames in the set of successive image frames. A known feature of coherent light is that it exhibits a variance in intensity over a time period that is greater than its mean intensity over that time period. In contrast, incoherent light exhibits a variance in intensity over a time period that is equal to its mean intensity over that time period. Based on this, the DSP unit 26 identifies each pixel location having a variance of intensity that is greater than a threshold value as a pixel location corresponding to coherent light (step 405). In this embodiment, the threshold value is the mean intensity. A grouping function is then performed to group pixel locations corresponding to coherent light, if any, that are within a threshold distance of each other (step 406). In this embodiment, the threshold distance is five (5) pixels. Of course, other threshold distances may be employed. A processed image frame is then generated using the mean intensity of each pixel location of the one or more groups of pixel locations corresponding to coherent light (step 408).

FIG. 8 shows a processed image frame 460 generated from a set of four (4) successive image frames, including the image frame 350, using the image frame processing method 400. As can be seen, the processed image frame 460 comprises a bright region 454 that corresponds to the bright region 354 of the image frame 350, and which results from coherent light emitted from the pen tool P. As ambient light is typically incoherent, the processed image frame 460 does not comprise any bright regions corresponding to the ambient light artifacts present in the image frame 350.

Once the processed image frame has been generated, the controller 120 processes the processed image frame by generating a vertical intensity profile (VIP) for each pixel column, and identifies intensity values that exceed a threshold value and that represent the likelihood that a pointer exists in the processed image frame. If no pen tool P exists in the successive image frames, the resulting processed image frame will not comprise any bright regions. As a result, the intensity values of the generated VIPs will not exceed the threshold value signifying that no pen tool exists. If one or more pen tools P exist in the successive image frames, the resulting processed image frame will comprise a bright region for each pen tool P. As a result, the intensity values of one or more generated VIPs will exceed the threshold value signifying that one or more pointers exist. The controller 120 in turn determines the peak locations of VIPs having intensity values surpassing the threshold value. Using the VIP peak locations, the controller 120 calculates the position of each pen tool P in (x,y) coordinates relative to the display surface 24 using triangulation in the well known manner, such as described in above-incorporated U.S. Pat. No. 6,803,906 to Morrison et al. Approaches for generating VIPs are described in U.S. Patent Application Publication No. 2009/0277697 to Bolt et al. entitled “Interactive Input System and Pen Tool Therefor” and assigned to SMART Technologies ULC, the relevant portions of the disclosure of which are incorporated herein by reference.

Once the position of each pen tool P has been determined, it is conveyed by the controller 120 to the general purpose computing device 30 via the USB cable 32. The general purpose computing device 30 in turn processes the received pointer coordinates, and updates the image output provided to the display unit, if required, so that the image presented on the display surface 24 reflects the pointer activity.

Although an embodiment has been described above with reference to FIGS. 1 to 8, alternatives are contemplated. For example, to reduce generation of any false positives, the image frame processing method may alternatively use more than four (4) successive image frames to identify pixel locations corresponding to coherent light. The image frame processing method may also include a statistical stationarity step to determine whether any group of pixel locations corresponding to coherent light is associated with movement of a light source over the set of successive image frames. Such a statistical stationarity step would also reduce the effects of any intrinsic variance in pixel gain levels within a group of pixels.

Turning now to FIGS. 9 to 11, another embodiment of an interactive input system is shown and is generally identified by reference numeral 520. In this embodiment, interactive input system 520 comprises an upright display surface 524 mounted on a wall surface or the like or otherwise supported or suspended in an upright orientation. An overhead unit 526 is generally centrally mounted above the display surface 524. The overhead unit 526 is in communication with a general purpose computing device 530 that executes one or more application programs, via a wired connection such as for example a USB cable 532.

The overhead unit 526 comprises a base assembly 540, a digital signal processor (DSP) unit 544, a projection unit 546, a light curtain module 548, an imaging assembly 550, and a curved mirror 552.

The base assembly 540 comprises mounting structure (not shown) allowing overhead unit 526 to be mounted on the wall or other surface.

The DSP unit 544 communicates with the general purpose computing device 530 via USB cable 532. Alternatively, the DSP unit 544 may communicate with the general purpose computing device 530 over another wired connection such as for example, a parallel bus, an RS-232 connection, an Ethernet connection etc. or may communicate with the general purpose computing device 530 over a wireless connection using a suitable wireless protocol such as for example Bluetooth, WiFi, ZigBee, ANT, IEEE 802.15.4, Z-Wave, etc.

The projection unit 546 projects images received from the general purpose computing device 530 via a USB cable or other suitable wired or wireless communication link (not shown) onto the display surface 524 via curved mirror 552, as indicated by dotted lines 574a, shown in FIG. 14.

The light curtain module 548 comprises an infrared (IR) light source such as for example one or more IR laser diodes and optical components that receive the laser diode output and generate a coherent light plane 560, as shown in FIG. 14. The coherent light plane 560 is spaced from and is generally parallel to the display surface 524, and has a narrow width. In this embodiment, the coherent light plane 560 is generally continuously emitted.

The imaging assembly 550 has a field of view encompassing the display surface 524 via curved mirror 552, as indicated by dashed lines 570a in FIG. 14, and captures image frames thereof to detect IR light emitted by the light curtain module 548 that has been reflected by a pointer brought into proximity with the display surface 524. In this embodiment, imaging assembly 550 comprises an image sensor (not shown) having a resolution of 752×480 pixels, such as that manufactured by Micron under model No. MT9V034 and is fitted with an optical imaging lens (not shown). The optical imaging lens has an IR-pass/visible light blocking filter thereon (not shown) such that IR light emitted by the light curtain module 548 and reflected by a pointer brought into proximity with the display surface 524 appears in image frames captured by imaging assembly 550. The optical imaging lens provides the image sensor with a 160 degree field of view, suitable to cover a diagonal display surface of up to 102 inches in any of 16:9, 16:10 or 4:3 aspect ratios. The imaging assembly 550 communicates with DSP unit 544 via communication lines 554 and sends captured image frames thereto. The communication lines 554 may be embodied in a serial bus, a parallel bus, a universal serial bus (USB), an Ethernet connection or other suitable wired or wireless connection.

General purpose computing device 530 receives captured image frames from the DSP unit 544 and processes the captured image frames to detect pointer activity. The general purpose computing device 530 adjusts image data that is output to the projection unit 546 allowing the image presented on the display surface 524 to reflect pointer activity. In this manner, pointer activity proximate to the display surface 524 is recorded as writing or drawing or used to control the execution of one or more application programs executed by the general purpose computing device 530.

In the example shown in FIG. 9, pointers P1 and P2 are brought into proximity with the display surface 524 and break the coherent light plane 560. As a result, coherent light of the light plane 560 is reflected towards imaging assembly 550. In particular, pointers P1 and P2 each cause respective beams of coherent light to reflect back to imaging assembly 550. Pointers P1 and P2 in this embodiment are passive pointers such as fingers, styluses, erasers, balls or other suitable objects. A beam of light emitted by a coherent light source P3 in the form of a laser pointer results in the appearance of a bright spot 592 on the display surface 524, which is also visible to the imaging assembly 550.

Since ideal environments rarely exist during real world operation, sources of unwanted light may appear in image frames captured by imaging assembly 550. In FIG. 9, such unwanted light is represented by bright regions 594a, 594b and 594c, which may cause false pointer detections. Imaging assembly 550 comprises an IR pass filter to inhibit light outside of the IR spectrum from appearing in captured image frames. Therefore, only ambient light that is within the infrared spectrum appears in captured image frames. Ambient light is typically emitted in a broad spectrum including infrared.

FIG. 12 shows an image frame captured by the imaging assembly 550, and which is generally referred to using reference numeral 700. In this example, image frame 700 comprises a dark region 704 corresponding to the field of view of the imaging assembly 550, bright regions 706a and 706b corresponding to pointers P1 and P2 breaking the coherent light plane 560, a bright region 706c resulting from the beam of coherent light emitted by the coherent light source P3, and bright regions 706d to 706f resulting from ambient light.

To resolve pointer locations and remove sources of ambient light, the general purpose computing device 530 employs an image frame processing method, which is shown in FIG. 13 and generally indicated by reference numeral 800. For each image frame that has been captured, the general purpose computing device 530 stores the captured image frame in a buffer. The general purpose computing device 530 then processes the bright regions 706a to 706f using well-known image processing techniques, such as blob detection, and adjusts brightness and contrast, if necessary. A group of pixels within each bright region is then selected for further processing as a pixel group (step 802). In this embodiment, each pixel group comprises four (4) pixels located near the center of each bright region. The general purpose computing device 530 then calculates, for each pixel group, a mean intensity of the pixels of the pixel group and a variance of intensity for each pixel of the pixel group (step 804). Pixel groups comprising one or more pixels having a variance of intensity that is greater than a threshold value are then identified as pixel groups corresponding to coherent light (step 806). In this embodiment, the threshold value is the mean intensity. A processed image frame is then generated from the bright regions comprising the pixel groups corresponding to coherent light (step 808).

FIG. 14 shows a processed image frame 900 generated from the image frame 700 using the image frame processing method 800. The processed image frame 900 comprises bright regions 908a and 908b that correspond to the bright regions 706a and 706b of the image frame 700, and which result from pointers P1 and P2 breaking the coherent light plane 560. The processed image frame 900 also comprises a bright region 908c that corresponds to the bright region 706c of the image frame 700, and which results from the beam of coherent light emitted by the coherent light source P3. As ambient light is typically incoherent, the processed image frame 900 does not comprise bright regions corresponding to bright regions 706d to 706f present in the image frame 700.

Once the processed image frame has been generated, the general purpose computing device 530 analyzes the intensity value of each pixel in the processed image frame, and maps coordinates of bright regions in the image plane to coordinates in the display plane for interpretation as ink or mouse events by one or more application programs. Approaches for detecting one or more bright regions in image frames, and mapping the coordinates thereof to pointer positions, are described in U.S. Patent Application Publication No. 2010/0079385 to Holmgren et al. filed on Sep. 29, 2008 and assigned to SMART Technologies ULC, and International PCT Application No. PCT/CA2013/000024 filed on Jan. 11, 2013, the relevant portions of the disclosures of which are incorporated herein by reference.

Although the light curtain module is described above as emitting light generally continuously, those skilled in the art will appreciate that the light curtain module may alternatively pulse the emitted light such that it is in sequence with image frame capture.

Although the overhead unit is described as comprising the imaging assembly and the projection unit, in other embodiments, the imaging assembly and the projection unit may alternatively be separate units. In one such embodiment, the projection unit may alternatively be positioned behind the display surface, similar to configurations used in conventional rear-projection devices. In a related embodiment, the imaging assembly may also be positioned behind the display surface, such that the imaging assembly views the back of the display surface.

Also, although the light curtain module is used to provide a coherent light plane spaced from and generally parallel to the display surface, in other embodiments, other modules may be used to provide coherent light adjacent the display surface. For example, in one embodiment, a planar body within which totally internally reflected (TIR) coherent light propagates may be overlaid on the display surface, such that when a pointer contacts the planar body, the totally internally coherent light is frustrated at the contact locations, escapes from the planar body and appears in image frames captured by the imaging assembly.

In alternative embodiments, one or more light curtain modules may be integrated into the interactive input system 20 described above and with reference to FIGS. 1 to 8, so as to enable detection of other pointers, such as for example a finger, a passive stylus or pen tool or other passive object. In one such embodiment, a light curtain module is placed adjacent each imaging assembly 60, and provides a respective coherent light plane spaced from, and generally parallel to, the display surface 24. In the event that a passive pointer is brought into proximity with the input surface 24 and breaks the coherent light planes, coherent light is reflected back to the imaging assemblies 60, causing the passive pointer to appear in captured image frames.

Although in embodiments above, the sources of coherent light are infrared coherent light sources, in other embodiments, the interactive input systems may alternatively be configured to process coherent light generated by non-infrared coherent light sources, such as for example by visible light sources. In such embodiments, each imaging assembly may alternatively comprise a visible-pass/IR block filter, or may alternatively comprise no filter.

Although in embodiments described above, the tip of the active pen tool houses an illumination source configured to emit coherent light, and where the illumination source comprises one or more miniature infrared laser diodes, in other embodiments, illumination sources that emit other frequencies of light may alternatively be used.

Although in embodiments described above, the variance of intensity is compared to a threshold value to identify pixel locations corresponding to coherent light, where the threshold value is the mean intensity, in other embodiments, other threshold values may alternatively be used. In one such embodiment, the threshold value may alternatively be the mean intensity plus a number N of standard deviations of estimated noise. For example, estimated noise can be determined from one or more “background” image frames obtained during calibration under normal operating conditions, and when no pointers or pen tools are in proximity with the interactive surface/display surface. As an example, it has been found in laboratory testing that a threshold value of the mean intensity plus five (5) standard deviations of estimated noise yields a low number of false positives.

Although embodiments have been described above with reference to the accompanying drawings, those of skill in the art will appreciate that variations and modifications may be made without departing from the scope thereof as defined by the appended claims.

What is claimed is:

1. A method of determining pointer position in an interactive input system, the method comprising:
identifying pixels of at least one captured image frame as being associated with coherent light;
generating a processed image frame from the identified pixels; and
determining from said processed image frame a position of at least one pointer that emits coherent light.

2. The method of claim 1, wherein said identifying comprises:
determining an intensity variance for pixels of said at least one captured image frame; and
identifying pixels having an intensity variance above a threshold value as being associated with coherent light.

3. The method of claim 2, further comprising determining a mean intensity for said pixels of said at least one captured image frame, and using said mean intensity as said threshold value.

4. The method of claim 2, further comprising determining a mean intensity for said pixels of said at least one captured image frame, and using said mean intensity plus one or more standard deviations of estimated noise as said threshold value.

5. The method of claim 3, further comprising grouping pixels associated with coherent light that are within a threshold distance of each other.

6. The method of claim 4, further comprising grouping pixels associated with coherent light that are within a threshold distance of each other.

7. The method of claim 1, wherein said identifying comprises identifying pixels of a plurality of successive captured image frames as being associated with coherent light.

8. The method of claim 7, wherein said identifying comprises:
determining an intensity variance for pixels of said captured image frames; and
identifying pixels having an intensity variance above a threshold value as being associated with coherent light.

9. The method of claim 8, further comprising determining a mean intensity for said pixels of said captured image frames, and using said mean intensity as said threshold value.

10. The method of claim 8, further comprising determining a mean intensity for said pixels of said captured image frames, and using said mean intensity plus one or more standard deviations of estimated noise as said threshold value.

11. The method of claim 9, further comprising grouping pixels associated with coherent light that are within a threshold distance of each other.

12. The method of claim 10, further comprising grouping pixels associated with coherent light that are within a threshold distance of each other.

13. The method of claim 1, wherein said at least one pointer is a pen tool having a diffused tip section configured to emit coherent light.

14. The method of claim 1, wherein said coherent light is coherent infrared light.

15. An interactive input system comprising:
at least one imaging device configured to capture image frames of a region of interest; and
one or more processors configured to:
process captured image frames to identify pixels associated with coherent light;
generate processed image frames from the identified pixels; and
determine from said processed image frames a position of at least one pointer that emits coherent light.

16. The interactive input system of claim 15, wherein the one or more processors are further configured to:
determine an intensity variance for pixels of captured image frames; and
identify pixels having an intensity variance above a threshold value as being associated with coherent light.

17. The interactive input system of claim 16, wherein the one or more processors are further configured to:
determine a mean intensity for said pixels of said captured image frames and use said mean intensity as said threshold value.

18. The interactive input system of claim 16, wherein the one or more processors are further configured to:
determine a mean intensity for said pixels of said captured image frames and use said mean intensity plus one or more standard deviations of estimated noise as said threshold value.

19. The interactive input system of claim 17, wherein the one or more processors are further configured to:
group pixels associated with coherent light that are within a threshold distance of each other.

20. The interactive input system of claim 18, wherein the one or more processors are further configured to:
group pixels associated with coherent light that are within a threshold distance of each other.

21. The interactive input system of claim 15, wherein said at least one pointer is a pen tool having a diffused tip section configured to emit said coherent light.

22. The interactive input system of claim 15, wherein said coherent light is coherent infrared light.

23. A method of processing at least one image frame captured in an interactive system, the method comprising:
determining an intensity variance for pixels of the captured image frame;
identifying pixels having an intensity variance above a threshold value as being associated with coherent light; and
generating a processed image frame from the identified pixels.

24. The method of claim 23, further comprising determining a mean intensity for said pixels of said captured image frame and using said mean intensity as the threshold value.

25. The method of claim 23, further comprising determining a mean intensity for said pixels of said captured image frame and using said mean intensity plus one or more standard deviations of estimated noise as the threshold value.

26. An interactive input system comprising:
at least one imaging device capturing image frames of a region of interest; and
one or more processors configured to process captured image frames to:
determine an intensity variance for pixels of captured image frames;
identify pixels having an intensity variance above a threshold value as being associated with coherent light; and
generate processed image frames from the identified pixels.

27. A non-transitory computer readable medium embodying program code, which when executed by one or more processors, causes an apparatus at least to:
determine an intensity variance for pixels of captured image frames;
identify pixels having an intensity variance above a threshold value as being associated with coherent light; and
generate processed image frames from the identified pixels.
